(19) United States
(12) Patent Application Publication
(10) Pub. No.: US 2008/0072727 A1
(43) Pub. Date: Mar. 27, 2008

(54) Hand tool with built-in measuring means

(76) Inventor: Marat Geyfen, San Francisco, CA (US)

Correspondence Address: Marat Geyfen, 469 30th Ave, San Francisco, CA, 94121, US

(21) Appl. No.: 11/901,161

(22) Filed: Sep. 14, 2007

Related U.S. Application Data
(60) Provisional application No. 60/826,534, filed on Sep. 21, 2006.

(51) Int. Cl. B26D 7/28

(52) U.S. Cl. 83/522.19

(57) ABSTRACT

A hand tool apparatus for cutting a portion of an object at a length is presented. The apparatus includes at least two movable parts arranged on a pivot point. A nose is at one end of the pivot point and a pair of handles at an opposite end of the pivot point for operating the parts to grasp the object and cut the portion of the object. The nose including a pair of opposing cutting blades positioned vertically at a distal end of the nose for cutting the portion of the object and a measuring scale disposed on at least one surface of the nose. When the object is inserted at the distal end, the length of the portion of the object extending inward from the distal end can be measured. When the parts are operated the measured length of the portion of the object is cut.

### CROSS-REFERENCE TO RELATED APPLICATIONS

The present Utility patent application claims priority benefit of the [U.S. provisional application for patent Ser. No. 60/826,534 filed on Sep. 21, 2006 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to hand tools. More particularly, the invention relates to handheld cutting devices and pliers with measuring means located on the devices.

### BACKGROUND OF THE INVENTION

When using cutting tools such as, but not limited to, handheld pliers designed for cutting, it is often difficult for the user to make precision cuts. For example, without limitation, if an optician is trimming temples for a pair of glasses, the optician needs to trim both of the temples to the same length. In order to do this, using current methods, the optician uses his eye to make the proper cut. This method requires the optician to cut one temple then line up the cut piece to the other temple to attempt to match the length of the cut. In many instances this method does not yield cuts of the same size, and the optician must take extra time to fine-tune the cuts so they are equal. However, if a method existed that enabled the optician to measure the size of the cut while making the cut, the optician could be faster and much more precise in his work. There are many other fields that may also benefit from an improved method for making precision cuts such as, but not limited to, making stained glass, metal cutting, tiling, automotive, dentistry, other medical fields, etc.

In view of the foregoing, there is a need for improved techniques for making precision cuts with a handheld tool that enables a user to measure the length of the cut while cutting.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a side perspective view of an exemplary pair of pliers with measuring means added to a nose portion of the pliers, in accordance with an embodiment of the present invention;

FIG. 2 is a side perspective view of an exemplary cutting device with measuring means on a nose portion of the cutting device, in accordance with an embodiment of the present invention; and

FIG. 3 is a side perspective view of an exemplary cutting device with measuring means on a nose portion of the cutting device, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a hand tool with built-in measuring means is presented.

In one embodiment, a hand tool apparatus for cutting a portion of an object at a length is presented. The apparatus includes at least two movable parts arranged on a pivot point including a nose at one end of the pivot point and a pair of handles at an opposite end of the pivot point for operating the parts to grasp the object and cut the portion of the object with the nose, the nose including a pair of opposing cutting blades positioned vertically at a distal end of the nose for cutting the portion of the object and a measuring scale disposed on at least one surface of the nose where when the object is inserted at the distal end, the length of the portion of the object extending inward from the distal end can be measured and when the parts are operated the measured length of the portion of the object is cut. In another embodiment, the at least two movable parts provide a pair of pliers. In another embodiment, the measuring scale is disposed on a plurality of surfaces of the nose such that the measuring scale can be viewed when the apparatus is operated in a plurality of different positions. Another embodiment includes an additional measuring scale disposed on at least one surface of the nose where the additional measuring scale includes a different unit of measurement than the measuring scale. In further embodiments, the nose further includes a flat horizontal surfaces extending inward from the cutting blades for grasping the measured length of the portion of the object, the nose further includes hooked shaped surfaces extending inward from the cutting blades, the pivot point includes multiple hinge points, the nose further includes multiple curved surfaces extending inward from the cutting blades, the measuring scale is disposed on the at least one surface of the nose by engraving and the measuring scale is disposed on the at least one surface of the nose by means for removably attaching. In other embodiment the object is a temple or arm for eyeglasses frames and dimensions of the parts and scale are suitable for cutting the temples of eyeglasses and the measuring scale includes a metric scale.

In another embodiment, a hand tool apparatus for cutting a portion of an object at a length is presented. The apparatus includes means for providing a pair movable parts including means for grasping the object and cutting the portion of the object and means for measuring the length of the portion of the object, the measuring means disposed on the pliers such that the measured length of the portion of the object is cut. Other embodiments further include an additional means for measuring where the additional measuring means includes a different unit of measurement than the measuring means and the measuring means is disposed on the parts by means for removably attaching.

In another embodiment a hand tool apparatus for cutting a portion of an object at a length is presented. The apparatus includes a measuring scale disposed on at least one surface of the hand tool apparatus where when the object is inserted at a distal end of the hand tool apparatus, the length of the portion of the object extending inward from the distal end can be measured and when the hand tool apparatus is operated the measured length of the portion of the object is cut. In another embodiment the measuring scale is disposed on a plurality of surfaces of the hand tool apparatus such that the measuring scale can be viewed when the apparatus is operated in a plurality of different positions. Another embodiment further includes an additional measuring scale disposed on at least one surface of the hand tool apparatus where the additional measuring scale includes a different unit of measurement than the measuring scale. In other embodiments the measuring scale is disposed on the at least one surface of the hand tool apparatus by means for removably attaching and the measuring scale includes a metric scale.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Embodiments of the present invention are implemented on handheld tools, such as, but not limited to, pliers, which are used to trim or cut objects in order to alter their length. The preferred embodiment of the present invention provides handheld pliers that are designed for cutting or trimming comprising two handles that function like scissors and a metric scale up to certain length depending on the nose length of the pliers. In the preferred embodiment, the blades of the pliers are designed in the vertical position at the front of the nose, instead of horizontally like on scissors. Depending on the embodiment, a measuring function may be added to an existing tool that has vertical blades, or a tool may be designed with a measuring function included.

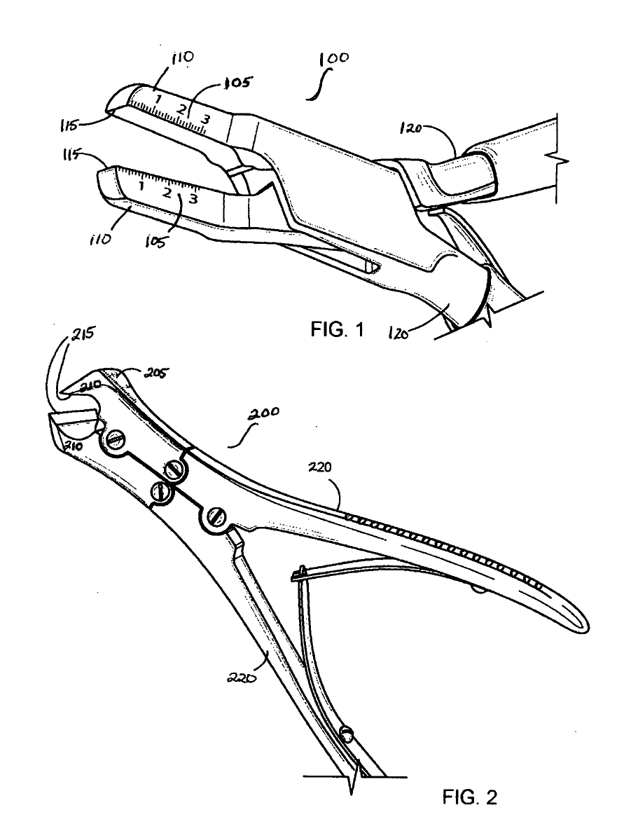

FIG. 1 is a side perspective view of an exemplary pair of pliers 100 with measuring means 105 added to a nose portion of pliers 100, in accordance with an embodiment of the present invention. In the present embodiment pliers 100 comprise solid straight nosepieces 110 with cutting blades 115 and handles 120 that operate similarly to scissors.

In the present embodiment, measuring means 105 comprise a metric ruler; however, alternate embodiments may use various other means for measuring the material or item for example, without limitation, rulers in other units such as, but not limited to, inches, drawings, other types of marks, etc. Measuring means 105 may be viewed from a top position and a bottom position, so if pliers 100 are held upside down, the logic of the function still exists. In some embodiments the units of the measuring means seen in the top position may differ from the units seen in the bottom position so the same pair of pliers can be used to cut and measure items and materials using different units. Measuring means 105 may vary in length as nosepieces 110 also vary in length depending on the intended use of pliers 100. In the present embodiment, measuring means 105 are located on the side of nosepieces 110; however, in alternate embodiments, measuring means may be located on the top and bottom surfaces of the nosepieces, and in other alternate embodiments, measuring means may be located on multiple surfaces including the top, bottom and side surfaces of the nosepieces.

In the present embodiment measuring means 105 are etched into the material of nosepieces 110. Typically nosepieces 110 are made of metal; however, in some embodiments the nosepieces may be made of other materials such as, but not limited to, plastics or ceramics. In alternate embodiments measuring means may be added to the nosepieces of the pliers with alternate methods such as, but not limited to, engraving or painting. In yet other alternate embodiments, the measuring means may be removably attached to the pliers, for example, without limitation, plastic additions or metal additions attached with screws or adhesives, paper or tape additions, magnetic additions, etc.

In typical use, an item is inserted between nosepieces 110 to the desired length on measuring means 105. Then, handles 120 are squeezed and the item is cut or trimmed to the desired length. For example, without limitation, if a user cuts 10 mm from a side of a temple by inserting the temple into nosepieces 110 up to the 10 mm mark of measuring means 105 and squeezing handles 120, the user can cut 10 mm from another temple by repeating the process. This enables the user to easily maintain symmetry in the temples. If more needs to be cut from the temples, then, using the same tool, the user may trim more until the desired size and length is achieved for each temple. The same process applies in cutting or trimming other items such as, but not limited to, screws, plastic sleeves, plastic fishing line, which is used for semi rimless eyewear, tiles, etc.

FIG. 2 is a side perspective view of an exemplary cutting device 200 with measuring means 205 on a nose portion of cutting device 200, in accordance with an embodiment of the present invention. In the present embodiment cutting device 200 comprises hooked nosepieces 210 with cutting blades 215 and handles 220 that operate using multiple hinge points. In the present embodiment measuring means 205 are a metric ruler; however, alternate embodiments may use various other measuring means. Measuring means 205 may be viewed from a top position and a bottom position, so if cutting device 200 is held upside down, the logic of the function still exists. In some embodiments the units of the measuring means seen in the top position may differ from the units seen in the bottom position so the same cutting device can be used to cut and measure items and materials using different units. Measuring means 205 may vary in length as nosepieces 210 may also vary in length depending on the intended use of cutting device 200. In the present embodiment, measuring means 205 are located on the top surface of one of the nosepieces 210; however, in alternate embodiments, measuring means may be located on the top and bottom surfaces of the nosepieces, and in other alternate embodiments, measuring means may be located on multiple surfaces including the top, bottom and side surfaces of the nosepieces.

In typical use of cutting device 200, a user inserts an item to be cut between nosepieces 210. The user measures the amount of material to be cut from the item by lining up the item with measuring means 205. When the correct length to be cut is reached, the user squeezes handles 220 together causing cutting blades to come together and cut the item. If more material needs to be removed from the item, the user may repeat the process as needed until the correct size and length is achieved for the item.

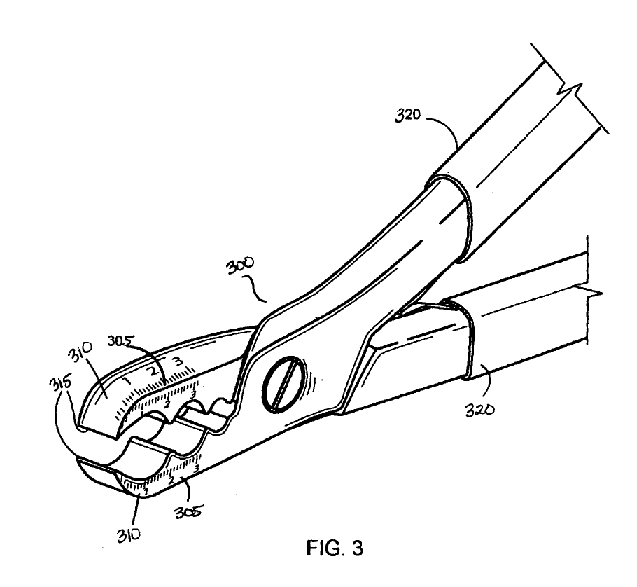

FIG. 3 is a side perspective view of an exemplary cutting device 300 with measuring means 305 on a nose portion of cutting device 300, in accordance with an embodiment of the present invention. In the present embodiment cutting device 300 comprises nosepieces 310 with multiple curved surfaces and cutting blades 315 and handles 320 that operate similarly to scissors. In the present embodiment measuring means 305 are a metric ruler; however, alternate embodiments may use various other measuring means. Because measuring means 305 is located on a top surface, a bottom surface and side surfaces of nosepieces 310, measuring means 305 may be viewed from a top position, a bottom position and a side position. In some embodiments the units of the measuring means seen on the various surfaces may differ from each other so the cutting device can be used to cut and measure items and materials using various different units. In some embodiments the measuring means may be located on only one surface. Measuring means 105 may vary in length as nosepieces 310 may also vary in length depending on the intended use of cutting device 300.

In typical use, cutting device 300 operates similarly to pliers 100 shown by way of example in FIG. 1. A user places an item to be cut between nosepieces 310 and lines up the item with the measurement corresponding to the desired length of the cut to be made on measuring means 305. Then, the user squeezes handles 320 together to cut the item.

Having fully described at least one embodiment of the present invention, other equivalent or alternative methods of implementing a handheld cutting device with measuring means according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A hand tool apparatus for cutting a portion of an object at a length, the apparatus comprising:
at least two movable parts arranged on a pivot point comprising a nose at one end of said pivot point and a pair of handles at an opposite end of said pivot point for operating said parts to grasp the object and cut the portion of the object with said nose, said nose comprising a pair of opposing cutting blades positioned vertically at a distal end of said nose for cutting the portion of the object; and
a measuring scale disposed on at least one surface of said nose where when the object is inserted at said distal end, the length of the portion of the object extending inward from said distal end can be measured and when said parts are operated the measured length of the portion of the object is cut.

2. The apparatus as recited in claim 1, where said at least two movable parts provide a pair of pliers.

3. The apparatus as recited in claim 1, where said measuring scale is disposed on a plurality of surfaces of said nose such that said measuring scale can be viewed when the apparatus is operated in a plurality of different positions.

4. The apparatus as recited in claim 1, further comprising an additional measuring scale disposed on at least one surface of said nose where said additional measuring scale comprises a different unit of measurement than said measuring scale.

5. The apparatus as recited in claim 2, wherein said nose further comprises a flat horizontal surfaces extending inward from said cutting blades for grasping the measured length of the portion of the object.

6. The apparatus as recited in claim 1, wherein said nose further comprises hooked shaped surfaces extending inward from said cutting blades.

7. The apparatus as recited in claim 1, wherein said pivot point comprises multiple hinge points.

8. The apparatus as recited in claim 1, wherein said nose further comprises multiple curved surfaces extending inward from said cutting blades.

9. The apparatus as recited in claim 1, wherein said measuring scale is disposed on said at least one surface of said nose by engraving.

10. The apparatus as recited in claim 1, wherein said measuring scale is disposed on said at least one surface of said nose by means for removably attaching.

11. The apparatus as recited in claim 1, wherein the object is a temple (arm) for eyeglasses and dimensions of said parts and scale are suitable for cutting the temples.

12. The apparatus as recited in claim 1, wherein said measuring scale comprises a metric scale.

13. A hand tool apparatus for cutting a portion of an object at a length, the apparatus comprising:
means for providing a pair movable parts comprising means for grasping the object and cutting the portion of the object; and
means for measuring the length of the portion of the object, said measuring means disposed on said pliers such that the measured length of the portion of the object is cut.

14. The apparatus as recited in claim 13, further comprising an additional means for measuring where said additional measuring means comprises a different unit of measurement than said measuring means.

15. The apparatus as recited in claim 13, wherein said measuring means is disposed on said parts by means for removably attaching.

16. A hand tool apparatus for cutting a portion of an object at a length, the apparatus comprising:
a measuring scale disposed on at least one surface of the hand tool apparatus where when the object is inserted at a distal end of the hand tool apparatus, the length of the portion of the object extending inward from said distal end can be measured and when the hand tool apparatus is operated the measured length of the portion of the object is cut.

17. The apparatus as recited in claim 16, where said measuring scale is disposed on a plurality of surfaces of the hand tool apparatus such that said measuring scale can be viewed when the apparatus is operated in a plurality of different positions.

18. The apparatus as recited in claim 16, further comprising an additional measuring scale disposed on at least one surface of the hand tool apparatus where said additional measuring scale comprises a different unit of measurement than said measuring scale.

19. The apparatus as recited in claim 16, wherein said measuring scale is disposed on said at least one surface of the hand tool apparatus by means for removably attaching.

20. The apparatus as recited in claim 16, wherein said measuring scale comprises a metric scale.
